SEQUENCE LISTING (2 sequences)

SEQ ID NO: 1 - DNA, 4851 bp, Solanum tuberosum
  CDS (105)..(4499)
  ref <308>: DATABASE ACCESSION NUMBER: EMBL / Y09533
  ref <309>: DATABASE ENTRY DATE: 1998-07-30
  ref <313>: RELEVANT RESIDUES IN SEQ ID NO: (105)..(4499)
catcttcatcgaatttctcgaagcttcttcgctaatttcctggtttcttcactcaaaatcgacgtttctagctgaacttgagtgaattaagccagtgggaggatatgagtaattccttagggaataacttgctgtaccagggattcctaacctcaacagtgttggaacataaaagtagaatcagtcctccttgtgttggaggcaattctttgtttcaacaacaagtgatctcgaaatcacctttatcaactgagtttcgaggtaacaggttaaaggtgcagaaaaagaaaatacctatggaaaagaagcgtgctttttctagttctcctcatgctgtacttaccactgatacctcttctgagctagcagaaaagttcagtctaggggggaatattgagctacaggttgatgttaggcctcccacttcaggtgatgtgtcctttgtggattttcaagtaacaaatggtagtgataaactgtttttgcactggggggcagtaaaattcgggaaagaaacatggtctcttccgaatgatcgtccagatgggaccaaagtgtacaagaacaaagcacttagaactccatttgttaaatctggctctaactccatcctgagactggagatacgagacactgctatcgaagctattgagtttctcatatacgatgaagcccacgataaatggataaagaataatggtggtaattttcgtgtcaaattgtcaagaaaagagatacgaggcccagatgtttctgttcctgaggagcttgtacagatccaatcatatttgaggtgggagaggaagggaaaacagaattacccccctgagaaagagaaggaggaatatgaggctgctcgaactgtgctacaggaggaaatagctcgtggtgcttccatacaggacattcgagcaaggctaacaaaaactaatgataaaagtcaaagcaaagaagagcctcttcatgtaacaaagagtgatatacctgatgaccttgcccaagcacaagcttacattaggtgggagaaagcaggaaagccgaactatcctccagaaaagcaaattgaagaactcgaagaagcaagaagagaattgcaacttgagcttgagaaaggcattacccttgatgagttgcggaaaacgattacaaaaggggagataaaaactaaggtggaaaagcacctgaaaagaagttcttttgccgttgaaagaatccaaagaaagaagagagactttgggcatcttattaataagtatacttccagtcctgcagtacaagtacaaaaggtcttggaagaaccaccagccttatctaaaattaagctgtatgccaaggagaaggaggagcagattgatgatccgatcctaaataaaaagatctttaaggtcgatgatggggagctactggtactggtagcaaagtcctctgggaagacaaaagtacatctagctacagatctgaatcagccaattactcttcactgggcattatccaaaagtcctggagagtggatggtaccaccttcaagcatattgcctcctgggtcaattattttagacaaggctgccgaaacacctttttcagccagttcttctgatggtctaacttctaaggtacaatctttggatatagtaattgaagatggcaattttgtggggatgccatttgttcttttgtctggtgaaaaatggattaagaaccaagggtcggatttctatgttggcttcagtgctgcatccaaattagcactcaaggctgctggggatggcagtggaactgcaaagtctttactggataaaatagcagatatggaaagtgaggctcagaagtcatttatgcaccggtttaatattgcagctgacttgatagaagatgccactagtgctggtgaacttggttttgctggaattcttgtatggatgaggttcatggctacaaggcaactgatatggaacaaaaactataacgtaaaaccacgtgaaataagcaaggctcaggacagacttacagacttgttgcagaatgctttcaccagtcaccctcagtaccgtgaaattttgcggatgattatgtcaactgttggacgtggaggtgaaggggatgtaggacagcgaattagggatgaaattttggtcatccagaggaacaatgactgcaagggtggtatgatgcaagaatggcatcagaaattgcataataatactagtcctgatgatgttgtgatctgtcaggcattaattgactacatcaagagtgattttgatcttggtgtttattggaaaaccctgaatgagaacggaataacaaaagagcgtcttttgagttatgaccgtgctatccattctgaaccaaattttagaggagatcaaaagggtggtcttttgcgtgatttaggtcactatatgagaacattgaaggcagttcattcaggtgcagatcttgagtctgctattgcaaactgcatgggctacaaaactgagggagaaggctttatggttggagtccagataaatcctgtatcaggcttgccatctggctttcaggacctcctccattttgtcttagaccatgtggaagataaaaatgtggaaactcttcttgagagattgctagaggctcgtgaggagcttaggcccttgcttctcaaaccaaacaaccgtctaaaggatctgctgtttttggacatagcacttgattctacagttagaacagcagtagaaaggggatatgaagaattgaacaacgctaatcctgagaaaatcatgtacttcatctccctcgttcttgaaaatctcgcactctctgtggacgataatgaagatcttgtttattgcttgaagggatggaatcaagctctttcaatgtccaatggtggggacaaccattgggctttatttgcaaaagctgtgcttgacagaacccgtcttgcacttgcaagcaaggcagagtggtaccatcacttattgcagccatctgccgaatatctaggatcaatacttggggtggaccaatgggctttgaacatatttactgaagaaattatacgtgctggatcagcagcttcattatcctctcttcttaatagactcgatcccgtgcttcggaaaactgcaaatctaggaagttggcagattatcagtccagttgaagccgttggatatgttgtcgttgtggatgagttgctttcagttcagaatgaaatctacgagaagcccacgatcttagtagcaaaatctgttaaaggagaggaggaaattcctgatggtgctgttgccctgataacaccagacatgccagatgttctttcacatgtttctgttcgagctagaaatgggaaggtttgctttgctacatgctttgatcccaatatattggctgacctccaagcaaaggaaggaaggattttgctcttaaagcctacaccttcagacataatctatagtgaggtgaatgagattgagctccaaagttcaagtaacttggtagaagctgaaacttcagcaacacttagattggtgaaaaagcaatttggtggttgttacgcaatatcagcagatgaattcacaagtgaaatggttggagctaaatcacgtaatattgcatatctgaaaggaaaagtgccttcctcggtgggaattcctacgtcagtagctcttccatttggagtctttgagaaagtactttcagacgacataaatcagggagtggcaaaagagttgcaaattctgatgaaaaaactatctgaaggagacttcagcgctcttggtgaaattcgcacaacggttttagatctttcagcaccagctcaattggtcaaagagctgaaggagaagatgcagggttctggcatgccttggcctggtgatgaaggtccaaagcggtgggaacaagcatggatggccataaaaaaggtgtgggcttcaaaatggaatgagagagcatacttcagcacaaggaaggtgaaactggatcatgactatctgtgcatggctgtccttgttcaagaaataataaatgctgattatgcatttgtcattcacacaaccaacccatcttccggagacgactcagaaatatatgccgaggtggtcaggggccttggggaaacacttgttggagcttatccaggacgtgctttgagttttatctgcaagaaaaaggatctcaactctcctcaagtgttaggttacccaagcaaaccgatcggccttttcataaaaagatctatcatcttccgatctgattccaatggggaagatttggaaggttatgccggtgctggcctctacgacagtgtaccaatggatgaggaggaaaaagttgtaattgattactcttccgacccattgataactgatggtaacttccgccagacaatcctgtccaacattgctcgtgctggacatgctatcgaggagctatatggctctcctcaagacattgagggtgtagtgagggatggaaagatttatgtcgttcagacaagaccacagatgtgattatattctcgttgtatgttgttcagagaagaccacagatgtgatcatattctcattgtatcagatctgtgaccacttacctgatacctcccatgaagttacctgtatgattatacgtgatccaaagccatcacatcatgttcaccttcagctattggaggagaagtgagaagtaggaattgcaatatgaggaataataagaaaaactttgtaaaagctaaattagctgggtatgatatagggagaaatgtgtaaacattgtactatatatagtatatacacacgcattatgtattgcattatgcactgaataatatcgcagcatcaaagaagaaatcctttgggtggtttc

SEQ ID NO: 2 - protein, 1464 aa, Solanum tuberosum
MSNSLGNNLLYQGFLTSTVLEHKSRISPPCVGGNSLFQQQVISKSPLSTEFRGNRLKVQKKKIPMEKKRAFSSSPHAVLTTDTSSELAEKFSLGGNIELQVDVRPPTSGDVSFVDFQVTNGSDKLFLHWGAVKFGKETWSLPNDRPDGTKVYKNKALRTPFVKSGSNSILRLEIRDTAIEAIEFLIYDEAHDKWIKNNGGNFRVKLSRKEIRGPDVSVPEELVQIQSYLRWERKGKQNYPPEKEKEEYEAARTVLQEEIARGASIQDIRARLTKTNDKSQSKEEPLHVTKSDIPDDLAQAQAYIRWEKAGKPNYPPEKQIEELEEARRELQLELEKGITLDELRKTITKGEIKTKVEKHLKRSSFAVERIQRKKRDFGHLINKYTSSPAVQVQKVLEEPPALSKIKLYAKEKEEQIDDPILNKKIFKVDDGELLVLVAKSSGKTKVHLATDLNQPITLHWALSKSPGEWMVPPSSILPPGSIILDKAAETPFSASSSDGLTSKVQSLDIVIEDGNFVGMPFVLLSGEKWIKNQGSDFYVGFSAASKLALKAAGDGSGTAKSLLDKIADMESEAQKSFMHRFNIAADLIEDATSAGELGFAGILVWMRFMATRQLIWNKNYNVKPREISKAQDRLTDLLQNAFTSHPQYREILRMIMSTVGRGGEGDVGQRIRDEILVIQRNNDCKGGMMQEWHQKLHNNTSPDDVVICQALIDYIKSDFDLGVYWKTLNENGITKERLLSYDRAIHSEPNFRGDQKGGLLRDLGHYMRTLKAVHSGADLESAIANCMGYKTEGEGFMVGVQINPVSGLPSGFQDLLHFVLDHVEDKNVETLLERLLEAREELRPLLLKPNNRLKDLLFLDIALDSTVRTAVERGYEELNNANPEKIMYFISLVLENLALSVDDNEDLVYCLKGWNQALSMSNGGDNHWALFAKAVLDRTRLALASKAEWYHHLLQPSAEYLGSILGVDQWALNIFTEEIIRAGSAASLSSLLNRLDPVLRKTANLGSWQIISPVEAVGYVVVVDELLSVQNEIYEKPTILVAKSVKGEEEIPDGAVALITPDMPDVLSHVSVRARNGKVCFATCFDPNILADLQAKEGRILLLKPTPSDIIYSEVNEIELQSSSNLVEAETSATLRLVKKQFGGCYAISADEFTSEMVGAKSRNIAYLKGKVPSSVGIPTSVALPFGVFEKVLSDDINQGVAKELQILMKKLSEGDFSALGEIRTTVLDLSAPAQLVKELKEKMQGSGMPWPGDEGPKRWEQAWMAIKKVWASKWNERAYFSTRKVKLDHDYLCMAVLVQEIINADYAFVIHTTNPSSGDDSEIYAEVVRGLGETLVGAYPGRALSFICKKKDLNSPQVLGYPSKPIGLFIKRSIIFRSDSNGEDLEGYAGAGLYDSVPMDEEEKVVIDYSSDPLITDGNFRQTILSNIARAGHAIEELYGSPQDIEGVVRDGKIYVVQTRPQM

(19) United States
(12) Patent Application Publication
(10) Pub. No.: US 2013/0059056 A1
(43) Pub. Date: Mar. 7, 2013

(54) USE OF MODIFIED WHEAT FLOUR FOR REDUCING BAKING LOSSES

(71) Applicants: Jens PILLING, Dortmund (DE); Walid Banafa, Berlin (DE)

(72) Inventors: Jens PILLING, Dortmund (DE); Walid Banafa, Berlin (DE)

(73) Assignee: Bayer CropScience AG, Monheim am Rhein (DE)

(21) Appl. No.: 13/593,392

(22) Filed: Aug. 23, 2012

Related U.S. Application Data
(63) Continuation of application No. 12/301,800, filed on Nov. 21, 2008, now abandoned.
(60) Provisional application No. 60/808,336, filed on May 25, 2006.

(30) Foreign Application Priority Data
May 24, 2006 (EP) EP06090087.5

(51) Int. Cl. A23L 1/0522

(52) U.S. Cl. 426/523

(57) ABSTRACT

The present invention relates to the use of wheat flour for reducing baking losses. The wheat flour can comprise genetically or chemically phosphorylated starch.

The present invention relates to the use of modified wheat flour for reducing baking losses without use of baking agents.

The quality of baked goods is effected by a plurality of factors: the raw materials and formulas; bulk proof, workup and also fermentation and baking conditions.

The choice of wheat variety has a great effect on the features of baking quality such as protein content and wet gluten content, baked volume and sedimentation value.

Baking loss (also termed bakeout loss) is taken to mean by those skilled in the art the weight loss of the dough or dough pieces during baking. Primarily this is evaporated dough water and also, to a minimal extent, other volatile constituents such as alcohol, organic acids and esters; therefore, those skilled in the art equally speak of “water loss”.

The baking loss proceeds in parallel to the temperature course in the dough piece during baking in that it is greatest in the edge regions (crust), because there the highest temperature prevails. In addition, the baking loss is greatly dependent on the baked good's size or the baked good's surface area. Relatively small baked goods, percentagewise, have a greater baking loss than larger baked goods. In addition to the size and shape of the bakery product, other factors also have an effect: for example dough processing and bulk proof, the crust fraction, baking time and oven temperature.

The mean baking losses are, for small baked goods, 18-22%, for 1000 g bread 13%, and for 2000 g bread 11%.

High baking losses have a disadvantageous effect on the baking yield of the baker and thus also on the weight and number of baked goods to be sold.

In addition, the water losses during the baking process have a disadvantageous effect on the freshness of the baked goods, which they thereby age earlier, that is to say stale.

This in turn impairs the flavor of the baked goods and thus what is termed “mouthfeel”.

Therefore there is a great need to reduce the baking losses in the production of dough products and to enhance properties such as improved flavor, improved mouthfeel and also the baking yield of the baker.

The present invention relates to the use of wheat flour having a phosphate content of at least 2 μmol of C-6-P/g of starch for reducing baking losses.

The expression “phosphate content”, in the context of the present invention, is taken to mean the content of phosphate groups which are bound at carbon atom position “6” of the glucose monomers of the flour. In principle, in starch, in vivo, positions C2, C3 and C6 of the glucose units can be phosphorylated. The phosphate content in the C6 position (=C-6-P content) is determined. In the context of the present invention, via glucose-6-phosphate determination using the optical-enzymatic test described hereinafter (according to Nielsen et al., 1994, Plant Physiol. 105, 111-117).

The expression “phosphate content of at least 2 μmol of C-6-P/g of starch”, in the context of the present invention, means that the content of phosphate groups which are bound at carbon atom position “6” of the glucose monomers is at least 2 μmol per gram of starch.

In a further embodiment, the flour used is modified in such a manner that the phosphate content is at least 2 μmol of C-6-phosphate/g of starch. In a preferred embodiment, the flour has a content of 2 to 10 μmol of C-6-phosphate/g of starch, particularly preferably 2 to 8 μmol of C-6-phosphate/g of starch, and very particularly preferably 4 to 6 μmol of C-6-phosphate/g of starch.

Wheat flour can have its phosphate content modified by various processes, this can be achieved, for example, by genetic modification of the wheat plant, or by means of chemical phosphorylation of the extracted starch.

In a preferred used, the wheat flour underlying the invention was modified. In a particularly preferred embodiment, the wheat flour underlying the invention was genetically modified. In the context of the present invention, “genetically modified wheat flour” means that the wheat flour originates from grains of a genetically modified wheat plant, its genetic modification leading to increase in the phosphate content of the starch compared with the phosphate content of a corresponding genetically unmodified wheat plant. In unmodified wheat flour, phosphate is not detectable in the starch at all, or only in traces.

In a further preferred use, wheat plants were used which express an R1 gene (alpha-glucan water dikinase, E.C.2.7.9.4; Lorberth et al. (1998) Nature Biotechnology 16: 473-477) from potato (Solanum tuberosum). The nucleotide sequences and amino acid sequences are reported in Seq ID No. 1 and Seq ID No. 2. The production of these plants is described extensively in the patent application WO 02/34923 (examples 1 and 2).

In a further preferred embodiment, the starch of the wheat flour underlying the invention was phosphorylated by chemical agents; this phosphorylation caused an increase of the phosphate content compared with the phosphate content of a corresponding wheat plant which was not chemically phosphorylated.

In baking processes, the addition of baking agents is a conventional procedure. Baking agents are taken to mean by those skilled in the art all substances which (are said to) cause an improvement in volume, yield, flavor, freshness retention and/or dough processing. Conventional baking agents are, for example, soy flour, xanthan, carboxymethylcellulose or pectins. These baking agents can also be used to reduce baking losses. However, their use gives rise to additional costs and requires in most cases a more or less complex adaptation of the dough processing and baking processes. In addition, it is required under food law to declare these baking agents as additives.

Soy is added as soy flour or as soy lecithin. Soy lecithin acts as an emulsifier, whereas improved water binding is described for soy powder. The addition of soy flour to wheat flour has been studied, inter alia, by Stauffer (2002, American Soybean Association, Europe and Maghreb). He describes a reduction of baking losses by 0.5 to 1.5% on addition of 3 to 5% of soy powder to wheat flour.

Xanthan (E415) is a naturally occurring polysaccharide which is produced in a biotechnological process by means of fermentation of glucose or sucrose by the bacterium Xanthomonas campestris. It is usable in versatile ways, for instance as thickener and stabilizer in the food and construction material industries and also for emulsions in paints and cosmetics. In the food industry it is also used as gluten substitute, inter alia in yeast-raised baked goods. Sidhu and Bawa 2002 (Int. Journal of Food Properties 5(1): 1-11) write that the addition of 0.2% xanthan to wheat flour increased the water absorption from 59 to 60.8%, the addition of 0.5% xanthan to 62%. The dough yield increased by 0.4-2.9% (addition of 0.1 and 0.5% xanthan) and the bread yield by 0.7-2.0%. Additions of greater than 0.3% xanthan, however, according to statements of the authors were accompanied with decreasing bread quality (“slightly gummy”).

Pectins (E440) are polysaccharides which are obtained from plants (apple pomace, beet cossettes, citrus peel) and are used as gelling agents and also as dietary fiber. Yaseen et al. (2001, Polish J. of Food and Nutrition Sc. 10/51 (4): 19-25) describe the effect of pectins as antistaling agents of bread. According to their studies, the addition of 1-2% pectin gave a reduction of baking losses by 1-1.5%, a fraction >1.5% pectin rather having an adverse effect on volume and stability of the breads.

Carboxymethylcellulose (=CMC; E466) is structurally chemically modified crystals of plant fibers, that is to say cellulose treated with lyes or chloroacetic acid. CMC is used inter alia as gelling and thickening agent and also water retention system and thus serves to prolong the freshness of foods. Sidhu and Bawa (2000, Int. Journal of Food Properties, 3(3): 407-419) observed an increase of water absorption from 1.4 to 8.6% compared with the control for an addition of 0.1 to 0.5% CMC to wheat flour. The specific volume and additional yield increased by 0.7 to 3.3%, the yields which were higher than 1%, being achieved with an addition of >0.3% CMC, but, according to statements by the authors, this was accompanied with a decreasing bread quality (“slightly gummy”).

In a preferred embodiment, in the use according to the invention the wheat flour comprises a genetically modified starch.

In a further embodiment, use is made of wheat flour having a phosphate content of at least 2 μmol of C-6-P/g of starch for reducing baking losses without simultaneous use of baking agents which reduce baking losses.

In a preferred embodiment, use is made of modified wheat flour, very particularly preferably of genetically modified wheat flour.

In a further embodiment, in the use according to the invention the flour used comprises a mixture of various flours, this flour mixture having a phosphate content of at least 2 μmol of C-6-P/g of starch.

In a preferred embodiment, the mixture is a mixture of at least one modified flour with at least one unmodified flour.

In a further preferred embodiment, in the composition according to the invention the flour used is composed of two or more different modified flours.

In a further preferred embodiment, the modified flours are genetically modified flours.

The use of flours which are composed of qualitatively different flours is absolutely customary for baking processes. Depending on end product, the mixture can be a mixture of (qualitatively) different wheat flours or a mixture of wheat flour with other flours or starch from other plants, for example cornstarch. Customarily, the flour mixture for the baker is already composed in the cereal mill.

“Baker” is in this context any type of enterprise which processes flour to bakery products. “Cereal mill” is to be taken to mean a mechanically operated milling plant in which cereal is processed to flour.

Surprisingly, it has been found that in the use according to the invention the baking loss as weight loss after the baking process in baked goods from modified wheat flour is lower by 0.1 to 10% than in baked goods which were produced from unmodified wheat flour.

In further advantageous embodiments, the weight loss is reduced by 0.1 to 8%, preferably by 0.2 to 5%, particularly preferably by 0.5 to 3%, and very particularly preferably by 1.0 to 2.5%.

“Weight loss” is taken to mean by those skilled in the art the baking loss during baking due to water evaporation. The weight loss (=baking loss) is based in principle on the dough weight and is the ratio of dough weight to bread weight. It is calculated as follows:

$$baking loss = \frac{dough weight - bread weight}{dough weight} \times 100$$

It was found that the weight loss of baked goods made from genetically modified wheat flour is lower as a percentage than in baked goods made from unmodified wheat flour; this was found most clearly in the case of baguettes (14.1 to 16.1%).

In the context of the present invention, the expression “baked goods” is to be taken to mean a broad term for dough pieces which can be in different “states”, that is unbaked, prebaked or end-baked.

Those skilled in the art take an unbaked dough to mean a dough for production of baked goods (for example rolls), which comprises all required ingredients, or already formed dough pieces therefrom, which have not yet been baked (what are called unbaked dough pieces). In contrast thereto, a prebaked dough is taken to mean dough pieces which for improved storage or for simplification for the consumer, have passed through a first baking procedure (which can absolutely comprise a plurality of steps) at the manufacturer's premises under defined conditions. For completion, a further baking operation is required by the final consumer. End-baked dough pieces are those which are sold by the specialist trade correspondingly freshly baked or are produced by the consumers themselves by a final baking operation of prebaked dough pieces.

In the context of the present invention, all baked goods (rolls, white pan bread (=WPB), baguettes, hamburger buns) which were produced from the genetically modified wheat flour described here (=TAAB) are termed, for linguistic simplification, by the collective expression TAAB baked goods.

In contrast thereto, wild type baked goods are taken to mean those which are produced from corresponding genetically unmodified flour (=wild type flour).

The expression “corresponding”, in the context of the present invention, means that on comparison of a plurality of articles, the articles in question which are being compared with one another, were held under the same conditions. In this context, the expression “corresponding” means that the baked goods which are compared with one another were produced and tested under the same conditions. With respect to the flour used, the expression “corresponding” means that the plants from which the flour used was ultimately obtained, were grown under the same cultivation conditions.

The expression “wild type wheat flour”, in the context of the present invention, means that this is flour which was produced from cereal from unmodified wild type wheat plants. These wheat plants serve as starting material for those wheat plants which were genetically modified for the use according to the invention; that is their genetic information, apart from the genetic modification introduced which leads to an increase in the phosphate content, corresponds to that of a genetically modified wheat plant.

A further use of the present invention is that the baking loss as water loss after the baking process is lower by 1 to 20% than in baked goods which were produced from unmodified wheat flour.

In further advantageous embodiments, the water loss is reduced by 1.0 to 15%, preferably by 1.5 to 10%, particularly preferably by 2 to 8%, and very particularly preferably by 2 to 5%.

Water loss (% water loss based on the water in the dough), in the context of the present invention, is taken to mean the liquid loss which occurred after the baking process.

For the production of dough from genetically modified flour or dough from unmodified (wild type) flour, differing amounts of water were added to the same amount of flour in order finally to obtain the same dough consistency. The unbaked dough pieces produced have the same weight, but contain different amounts of water. The dough consistency was measured using the farinograph (ICC standard 115/1) as described hereinafter in the method part.

Basing the above-described weight loss (=baking loss due to water evaporation) on the amount of water present in the dough, the actual percentage water loss can be calculated:

$$water loss ( \% ) = \frac{dough weight - bread weight}{dough water} \times 100$$

Surprisingly, the results of the present invention show a significant reduction of baking losses even without addition of baking agents. The water loss based on the water present in the dough was lower for all baked goods made from modified TAAB wheat flour than for the corresponding wild type baked goods. The water loss was most greatly decreased in the baguettes: whereas the wild type baguettes exhibited a water loss of 35.1%, in the TAAB baguettes it was only 30.1 and in the rolls 45.1%, compared with 46.9% for the wild type.

Thus the present invention stands out significantly from the reported studies with additives, that is the baking losses in the present invention are significantly lower.

In addition, surprisingly, in the use according to the invention it was found that the TAAB baked goods have an increased bread moisture. An increased bread moisture has a beneficial effect on longer freshness retention and a good flavor of the baked good. The bread moisture is dependent on the type of the baked good and on the baking process.

The moisture of the baked goods is calculated after drying as follows:

$$moisture ( \% ) = \frac{initial weight - end weight}{initial weight} \times 100$$

In the case of the use according to the invention, bread moisture is taken to mean the water content of the entire baked good, that is no distinction is made between crumb and crust; the latter obviously has a lower moisture than the crumb. Ideally, the bread moisture is increased by 0.5 to 5%. In a preferred embodiment, the bread moisture of the TAAB baked goods is increased by 1 to 5%, particularly preferably by 1.5 to 4%, and very particularly preferably by 1.5 to 3%.

In a further preferred embodiment, in the use according to the invention the wheat flour comprises a genetically modified starch.

The expression “genetically modified starch”, in the present invention, designates a wheat starch which was modified with respect to its phosphate content using genetic engineering methods in such a manner that, compared with wheat starch from genetically unmodified wild type plants, it has an increased phosphate content. For this, the R1 gene from potato (Solanum tuberosum) was transformed into wheat (Triticum aestivum), as described in WO 02/034923.

In a further embodiment, the genetically modified wheat starch is altered in such a manner that its phosphate content is 2 to 10 μmol of C-6-phosphate/g of starch. In a preferred embodiment, the starch has a content of 2 to 8 μmol of C-6-phosphate/g of starch, and very particularly preferably 4 to 6 μmol of C-6-phosphate/g of starch.

Equally, in the case of the TAAB baked goods, an increase of dough yield was observed compared with the dough yield of the wild type baked goods. Dough yield is taken to mean by those skilled in the art the dough weight based on 100 parts of flour. In a further embodiment of the present invention, the dough yield of the TAAB doughs is increased by 1 to 10% compared with the wild type doughs, preferably by 2 to 8%, and particularly preferably by 3 to 5%.

In the use according to the invention, in addition, the baking yield in the case of baked goods made from modified wheat flour is increased by 1 to 10% compared with baked goods made from unmodified wheat flour.

Baking yield, in the context of the present invention, is taken to mean the weight of the baked goods achieved based on 100 parts of flour. In a further preferred embodiment, the baking yield is increased by 2 to 10%, particularly preferably by 3 to 8%, and very particularly preferably by 4 to 6%.

The greatest increase in baking yield resulted for the baguettes, in this case the yield of the TAAB baked goods was 5% higher than that of the wild type baked goods.

Material and Methods

In the examples use was made of the following methods. Use can be made of these methods to carry out the process according to the invention, they are specific embodiments of the present invention, but do not restrict the present invention to these methods. It is known to those skilled in the art that they can carry out the invention in an identical manner by modifying the described methods and/or by replacing individual method parts by alternative method parts.

1. Plant Material for Production of the TAAB Flour

Use was made of wheat plants (Triticum aestivum) which express an R1 gene (alpha-glucan water dikinase, E.C.2.7.9.4; Lorberth et al. (1998) Nature Biotechnology 16: 473-477) from potato (Solanum tuberosum). The exact production of these plants (sequence used ID No. 1, transformation method, vectors used, selection of transgenic plants) is described extensively in patent application WO 02/34923 (in examples 1 and 2). The nucleotide and amino acid sequences of the R1 gene are reported in Seq ID No. 1 and Seq ID No. 2. The transformation proceeded according to the method of Becker et al., 1994, Plant J. 5(2): 229-307.

Ripe grains were harvested from these wheat plants (Line TAAB-40A-11-8). These grains, the flour obtained therefrom and also the starch were studied chemically and rheologically. The controls used were wheat plants of unmodified wild type variety Florida which were grown under the same cultivation conditions.

Growth of Plants:

The seeds were planted out in the open air after previous vernalization. The plants used were grown and cultivated as follows:

Plant Protection:

before planting out the seed the seed material was pretreated with imidacloprid (Gaucho, Bayer) to combat insect damage (100 cc/100 kg of seed material).

Preemergence herbicide: diflufenican (Brodal), 250 cc/ha;

Herbicides (postemergence): metsulfuron methyl (=sulfonylurea derivative; application: 6.7 g/ha; DuPont) and dicamba (application: 0.12 l/ha);

Fungicide: epoxiconazole (Allegro, application: 0.85 l/ha);

Fertilization:

UREA (NH₂)₂CO: 125 kg/ha to blossom; thereafter 100 kg/ha.

2. Production of the TAAB Flour

200 kg of wheat grains of line TAAB 40A-11-8 were ground using a Bühler-Mahlautomat (Gebr. Bühler Maschinenfabrik, Uzwill, Switzerland). 200 kg of wheat grains yielded 140 kg of four type 550 (yield 70%).

3. Extraction of Starch

The wheat starch was isolated from the wheat flour using distilled water by means of the Perten-Glutomatic machine (Perten Instruments), as described in ICC-Standard No. 155. The starch was extracted with acetone, air-dried for 2 to 3 days and then ground in a mortar to powder.

4. Moisture Measurement

The moisture of the bread sample is determined using a moisturemeter (Sartorius, Göttingen, Germany). The sample is dried at 115° C. until the weight no longer decreases. The calculation proceeds according to the formula:

$$moisture ( \% ) = \frac{initial weight - end weight}{initial weight} \times 100$$

5. Determination of the Starch Phosphate Content in the C6 Position (C6-P Content)

In the starch, positions C3 and C6 of the glucose units can be phosphorylated. To determine the C6-P content of the starch (as described by Nielsen et al., 1994, Plant Physiol. 105: 111-117), 100 mg of wheat starch were hydrolyzed in 500 μl of 0.7 M HCl for 4 h at 95° C. with continuous shaking. Subsequently, the batches were centrifuged for 10 min at 13 000 rpm and the supernatants purified from suspended matter and turbidity by means of a filter membrane (0.45 μM). 20 μl of the clear hydrolyzate were mixed with 180 μl imidazole buffer (300 mM imidazole, pH 7.4; 7.5 mM MgCl₂, 1 mM EDTA and 0.4 mM NADP). The measurement was carried out in a photometer at 340 nm. After measurement of the base absorption, the enzyme reaction was started by adding 2 units of glucose-6-phosphate dehydrogenase (from Leuconostoc mesenteroides, Boehringer Mannheim). The change in absorption is based on equimolar reaction of glucose-6-phosphate and NADP to form 6-phosphonogluconate and NADPH, the formation of NADPH being measured at the abovementioned wavelength. The reaction was followed until a plateau was reached. The result of this measurement is the content of glucose-6-phosphate in the hydrolyzate. From the identical hydrolyzate, on the basis of the content of glucose liberated, the degree of hydrolysis was determined. This is used to relate the content of glucose-6-phosphate to the fraction of hydrolyzed starch from the amount of fresh weight. For this 10 μl of hydrolyzate were neutralized by 10 μl of 0.7 M NaOH and subsequently diluted 1:100 with water. 4 μl of this dilution were admixed with 196 μl of measurement puffer (100 mM imidazole pH 6.9; 5 mM MgCl₂, 1 mM ATP, 0.4 mM NADP) and used for determination of the base absorption. The reaction was followed by adding 2 μl of enzyme mix (Hexokinase 1:10; glucose-6-phosphate dehydrogenase from yeast 1:10 in measurement puffer) and at 340 nm to the plateau. The measurement principle corresponds to the first reaction.

The result of this measurement gives the amount of glucose (in mg) which was liberated from the starch present in the starting material in the course of hydrolysis.

Subsequently, the results of both measurements are related, in order to express the content of glucose-6-phosphate per mg of hydrolyzed starch.

Other than in the case of relating the amount of glucose-6-phosphate to the fresh weight of the sample, by this calculation the amount of glucose-6-phosphate is only based on that part of the starch which was completely hydrolyzed to glucose and thus is also to be considered the source for glucose-6-phosphate.

6. Analytical Data of the Flours

The TAAB flour and also the wild type wheat flour were analyzed by standard methods of the (International Association for Cereal Science and Technology=ICC/www.icc.or.at) or of the American Association of Cereal Chemists (MCC/www.aaccnet.org). The standard used in each case is listed in brackets. Since it can be requested on the respective Internet page, it will not be described here again. The following parameters were studied:
1. Ash content (ICC Standard 104/1)
2. Protein content (ICC Standard 105/2)
3. Wet gluten content (ICC Standard 137/1)
4. Gluten Index (ICC Standard 155)
5. Sedimentation value (ICC Standard 116/1)
6. Degree of starch damage (AACC Method 76-31)
7. Falling number (AACC Method 22-08)
8. Farinograph (ICC Standard 115/1)

7. Baking Experiments Procedure

The baking experiments were carried out at Bayer BioScience GmbH (Potsdam, Germany) according to standard methods. Use was made for this not only of flour from genetically modified wheat plants, but also flour from wild type wheat plants as a control.

### BRIEF DESCRIPTION OF THE DRAWINGS

FIG. 1 shows an overview of various baking processes.

### COMPOSITIONS AND METHODS OF THE BAKING EXPERIMENTS

7.1 Prebaked Frozen Baguettes

| Ingredients | Baker %* |
|---|---|
| Flour | 100 |
| Salt | 2.0 |
| ^{a}Water | variable |
| Yeast (fresh) | 2.0 |

^{a}Water as determined by the farinograph (+3%)
*Flour is set at 100%, the other components are then added thereto

Mixer: Spiral mixer (Diosna, 221—Diosna Dierks & & Söhne GmbH, Osnabrück/Germany)
Mix: Two minutes at speed one (100 rpm)
   Three minutes at speed two (200 rpm)
   Desired dough temperature is 24° C.
Proof: 20 minutes
Division: Divide dough into dough pieces of 115 g, round by hand and form into the length
Piece proof: The formed loaves are placed into baguette molds and fermented in the fermentation cabinet for 90 minutes at 24° C. and 87% relative humidity
Baking: 30 sec at 240° C.
   2.00 min at 210° C.
   15.30 min at 200° C.

During the baking process, the baguettes were sprayed with 80 ml of H₂O.
Freezing: Prebaked baguettes are frozen at −70° C. for 1 h, thereafter stored in the deep freeze at −18° C.
Baking out: After storage for one week, the prebaked baguettes are end-baked at 215° C. for 12 minutes.

7.2 Rolls

| Ingredients | Baker %* |
|---|---|
| Flour | 100 |
| Salt | 2.0 |
| Yeast (fresh) | 6.0 |
| Baking fat | 1.0 |
| Sugar | 1.0 |
| Water^{a} | variable |

^{a}Water as determined by the farinograph

Mix: Two minutes at speed one (100 rpm)
   Three minutes at speed two (200 rpm).
   Desired dough temperature=27° C.
Proof: 20 minutes
Scale: The dough is placed onto a forming plate and divided into 30 dough pieces using a dividing and rounding machine
Piece proof: The forming plate with the divided and formed dough is stored in the fermentation cabinet for 35 minutes at 32° C. and 87% relative humidity
Baking: 30 sec at 240° C.
   2.00 min at 210° C.
   15.30 min at 200° C.

During the baking process the rolls are sprayed with 80 ml of H₂O.

7.3 Starter and Dough for White Pan Bread (WPB)

| Ingredients | Baker %* |
|---|---|
| Starter: | |
| Flour | 70.0 |
| Yeast (fresh) | 2.0 |
| Food yeast (without oxidants) | 0.5 |
| Water | 42.0 |
| Dough: | |
| Flour | 30.0 |
| Granulated sugar | 7.0 |
| Baking fat | 3.0 |
| Salt | 2.0 |
| Calcium propionate | 0.25 |
| Water^{a} | variable (17.0) |

^{a}Water is calculated on the basis of 59% of the amount of flour
*Flour is set at 100%, the other components are then added thereto

Mixer: Hobart A-120 Mixer (Hobart Corporation/OH/USA) with McDuffee bowl
   and fork kneading attachment
Starter: Mixing the ingredients for 1 minute at speed 1 (=104 rpm)
   Further mixing for 1 minute at speed 1.
   Dough temperature after mixing: 26° C.±1° C.
Fermentation: Fermentation proceeds at 29° C. for 4 hours in a foil-covered vessel
Dough: The dough ingredients are mixed in a mixing bowl for 30 seconds at speed 1 (=104 rpm).
   Addition of starter and mixing for a further 30 seconds at speed 1 (=104 rpm)
   Mixing the dough at speed 2 (194 rpm) to optimum gluten development (recognizable on squeezing the dough between fingers).
   Ideal dough temperature is 26° C.±1° C.
Proof time: Proofing the dough for 20 minutes at 29° C. in a covered vessel.
Dividing into 2 loaves per batch (524 g per loaf)
Intermediate fermentation: Dough pieces (524 g) proof for 10 minutes at room temperature
Forming: Roller forming machine
   Dimensions: top roll: 0.87 cm; bottom roll: 0.67 cm;
   Press plate: 3.1 cm; press plate width: 23 cm.
Fermentation: The formed loaves are placed into bread molds in the fermentation cabinet at 43° C. and 81.5% relative humidity. The dough should expand up to 1.5 cm above the top rim of the bread mold.
Baking: 20 minutes at 215° C.
Bread mold dimensions: Top (inside): 25×10.8 cm
(estimated) Bottom (outside): 24.1×7.6 cm.
   Depth (inside): 7 cm

7.2. Starter and Dough for Hamburger Buns

| Ingredients | Baker %* |
|---|---|
| Starter: | |
| Flour | 70.0 |
| Yeast (fresh) | 3.0 |
| Water | 46.0 |
| Food yeast | 0.3 |
| Dough: | |
| Flour | 30.0 |
| High fructose corn syrup (42%) | 18.0 |
| Baking fat | 6.0 |
| Salt | 2.0 |
| Water | variable |
| Calcium propionate | 0.12 |

*Flour is set at 100%, the other components are then added thereto

Mixer: Hobart A-120 Mixer (Hobart Corporation/OH/USA) with McDuffee bowl and fork kneading attachment
Mixing dough: Mixing the ingredients for 1 minute at speed 1 (104 rpm). Further mixing for 1 minute at speed 1 (104 rpm).
   After mixing the mixing dough should have a temperature of 26° C.±1° C.
Fermentation: The fermentation proceeds at 29° C. for 3.5 hours in a foil-covered vessel
Bread dough: The dough ingredients are mixed in a mixing bowl for 30 seconds at speed 1 (104 rpm).
   Addition of the mixing dough and mixing for a further 30 seconds at speed 1
   Mixing the dough at speed 2 (194 rpm) up to optimum gluten development.
   Ideal dough temperature is 26° C.±1° C.
Proof time: Proofing the completely mixed dough for 10 minutes at 29° C. in a covered vessel.
Intermediate step: Dividing the dough into pieces of 56 g which are brought into a round flat form
Piece proof: The formed loaves are placed into bread molds and introduced into the fermentation cabinet at 43° C. and 90% relative humidity.
   The dough should expand to 3.6 cm.
Baking: 11 minutes at 224° C.
Bread dimensions: Weight (g) and volume (cc); measurement proceeds
   30 minutes after baking.

### EXAMPLES

### Example 1

### Production of Genetically Modified Wheat Plants

The vector pUbiR1 which was used for transformation of the wheat plants was produced as described in WO 02/034923 (example 1). Likewise, in WO 02/034923 (example 2) production is described of the genetically modified wheat plants which carry the R1 gene from potatoes (Solanum tuberosum).

For the process according to the invention, genetically modified wheat plants of line TAAB 40A-11-8 were used. Seed material of this line and also of the unmodified wheat “Florida” (hereinafter termed “wild type”) was planted as seed in Argentina and harvested.

### Example 2

### Compilation of the Properties of Wheat Flour of the Genetically Modified Line Compared with Unmodified Flour

Analysis of the wheat flours was performed according to standard methods of the ICC or of the American Association of Cereal Chemists (AACC). The following parameters were studied:
1. Ash content (ICC 104/1)
2. Protein content (ICC 105/2)
3. Wet gluten content (ICC 137/1)
4. Gluten index (ICC 155)
5. Sedimentation value (ICC 116/1)
6. Damaged starch (AACC 76-31)
7. Falling number (AACC 22-08)
8. Farinograph (ICC 115/1)

TABLE 1
Analytical data of the flours:

| Parameter | Wild type | TAAB 40A-11-8 |
|---|---|---|
| Ash content (%) | 0.56 | 0.58 |
| Protein % (Kjeldahl) | 13.8 | 14.5 |
| Wet gluten content (%) | 31 | 33 |
| Gluten index (%) | 80 | 76 |
| Sedimentation value (ml) | 38 | 39 |
| Damaged starch (%) | 5 | 5.6 |
| Falling number (s) | 418 | 451 |
| Farinograph: | | |
| Water absorption (%) | 58 | 62 |
| Dough development time (min) | 6 | 6.5 |
| Dough stability (min) | 10 | 11 |

Comparison of the analytical data shows that the modified TAAB flour, with retention of quality parameters, has a higher water absorption value than the modified wild type flour.

### Example 3

### Compilation of the Properties of Wheat Starch of the Genetically Modified Line Compared with Wild Type

TABLE 2
Properties of the wheat starches: compilation of the parameters
and results described in WO 02/034923:

| Line | Wild type | TAAB 40A-11-8 |
|---|---|---|
| C-6-P in nmol/mg of starch | Not detectable | 5.0 |
| RVA | 100% | 124% |
| Max | | |
| Min | 100% | 132% |
| Fin | 100% | 135% |
| T | 100% | 97% |
| Gel strength | 100% | 164% |
| DSC | 64° C. | 61° C. |
| Tpeak | | |
| Tonset | 58° C. | 56° C. |

### Example 4

### Results of Baking Experiments

TABLE 3
Weight and liquid losses and also yield of various baked
products after baking:

| | Rolls | | Baguette | |
|---|---|---|---|---|
| | TAAB | WT | TAAB | WT |
| Weight loss % | 19.9 | 20.2 | 14.1 | 16.1 |
| Water loss/water in | 45.1 | 46.9 | 30.1 | 35.1 |
| dough % | | | | |
| Bread moisture % | 30.3 | 28.6 | 38.1 | 35.5 |
| Bread moisture/volume | 66 | 64 | 182 | 166 |
| (mg/ml) | | | | |
| Dough yield % | 170.6 | 166.2 | 168.6 | 166 |
| Baking yield (%) | 137 | 133 | 144 | 139 |

Comparison of the products of genetically modified (TAAB) and unmodified wheat flour (WT). WPB=white pan bread/buns=hamburger buns.

Baking loss is the weight loss during baking owing to water evaporation. The baking loss in percent is fundamentally based on the dough weight, it is calculated as follows:

$$baking loss ( \% ) = \frac{dough weight - bread weight}{dough weight} \times 100$$

The results show that the weight loss of the bakery products from modified wheat flour is lower as a percentage than with the wild type.

By relating the weight loss to the amount of water present in the dough, the actual water loss can be calculated:

$$water loss ( \% ) = \frac{dough weight - bread weight}{dough water} \times 100$$

The water loss is calculated from the height of water addition which is different from the different flours and their water binding capacity in order to obtain the same dough consistency. The liquid loss of the bakery products of modified wheat flour is also less than that of the bakery products which were produced from unmodified flour.

The bread moisture based on the volume for all bakery products made from modified wheat flour was significantly higher than with the bakery products from unmodified wheat flour. The increased bread moisture has a beneficial effect on improved freshness retention of bakery products (extended shelf life).

The moisture was calculated as follows:

$$moisture ( \% ) = \frac{initial weight - end weight}{initial weight} \times 100$$

1. A method for reducing baking loss comprising baking a product comprising a wheat flour having a phosphate content of at least 2 μmol of C-6-P/g of starch without simultaneous use of baking agents which reduce baking losses.

2. The method of claim 1, wherein said wheat is modified wheat flour.

3. The method of claim 1, wherein the baking loss as weight loss after the baking process in baked goods from modified wheat flour is lower by 0.1 to 10% than in baked goods which were produced from unmodified wheat flour.

4. The method of claim 1, wherein the baking loss as water loss after the baking process is lower by 1 to 20% than in baked goods which were produced from unmodified wheat flour.

5. The method of claim 1, wherein the baking yield in baked goods made from modified wheat flour is increased by 1 to 10%.

6. The method of claim 1, wherein the wheat flour comprises a genetically modified starch.

7. The method of claim 3, wherein the baking loss as weight loss after the baking process in baked goods from modified wheat flour is lower by 2 to 8% than in baked goods which were produced from unmodified wheat flour.

8. The method of claim 7, wherein the baking loss as weight loss after the baking process in baked goods from modified wheat flour is lower by 3 to 5% than in baked goods which were produced from unmodified wheat flour.

9. The method of claim 4, wherein the baking loss as water loss after the baking process is lower by 1 to 15% than in baked goods which were produced from unmodified wheat flour.

10. The method of claim 5, wherein the baking yield in baked goods made from modified wheat flour is increased by 2 to 10%.

11. The method of claim 10, wherein the baking yield in baked goods made from modified wheat flour is increased by 3 to 8%.

12. The method of claim 11, wherein the baking yield in baked goods made from modified wheat flour is increased by 4 to 6%.
